(19) United States
(12) Patent Application Publication
(10) Pub. No.: US 2008/0198617 A1
(43) Pub. Date: Aug. 21, 2008

(54) LED Adaptive Forward Lighting Systems

(75) Inventors: Leo F. Schwab, Fraser, MI (US); Alfred M. Allen, Leonard, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/677,065

(22) Filed: Feb. 21, 2007

(51) Int. Cl. B60Q 1/068; F21S 8/10; F21V 21/26; F21V 14/02

(52) U.S. Cl. 362/545; 362/525; 362/250; 362/428

(57) ABSTRACT

An LED adaptive forward lighting system for an automotive vehicle comprises a headlamp housing fixed to the vehicle for mounting LED lamp units having fixed light beam directions. The LED lamp units each have mounting pivots and link pivots that are spaced from one another to provide lever arms. The mounting pivots mount the LED lamp units on a bezel within the housing. A link is provided both to the link pivots on the LED lamp units and to an axially translational shaft driven by a motor that is restrained with respect to the vehicle. When the drive shaft reciprocates, the LED lamp units rotate and shift the direction of the light beams thereof with respect to the longitudinal axis of the vehicle.

### FIELD OF THE INVENTION

The present invention relates to LED adaptive forward lighting systems for vehicles. More particularly, the present invention relates to such lighting systems wherein the line of focus angularly shifts laterally as a vehicle turns in order to provide illumination in the direction of the turn. Such systems are known as adaptive forward lighting (AFL) systems.

### BACKGROUND OF THE INVENTION

Currently, adaptive forward lighting (AFL) for automotive vehicles uses conventional lamp technology in which the light source is a High Intensity Discharge (HID) projector lamp or a halogen reflector arrangement. The projector lamp has a drive system, which is coupled to a vehicle's steering system so that as the steering wheel is turned, the headlights swivel to better illuminate the path over which the vehicle is traveling. Due to their light source, HID projector lamps are packaged with a width and length, which limits the degree of inboard rotation to about 5°. In addition, the packages for HID projector lamps are relatively large as compared to LED lamps. This is due at least in part to the size of the projection unit, the size of its light source, clearance to pivot the unit, and clearance to the outer lens due to high temperatures of the unit. LED headlamps, which use an array of LED light sources are not currently available for adaptive forward lighting (AFL) systems. LED headlamps have advantages over HID headlamps because LED headlamps can be packaged in a smaller volume than HID headlamps.

### SUMMARY OF THE INVENTION

An LED adaptive forward lighting system for an automotive vehicle comprises a headlamp housing fixed to the vehicle for mounting at least one LED light source in at least one LED lamp unit. The LED lamp unit has a mounting pivot and a link pivot that are spaced from one another to provide a lever arm. The mounting pivot mounts the LED lamp unit on a bezel. A link is pivoted both to the link pivot on the LED lamp unit and to an axially translatory shaft driven by a motor that is restrained with respect to a bezel. When the drive shaft translates, the LED lamp unit rotates about the mounting pivot and shifts the light beam thereof with respect to the axis of the vehicle.

In a further aspect of the system, there is at least one additional LED lamp unit pivoted to the bezel, with each LED lamp unit being pivotally connected to the link and thus to the axially translatory shaft.

In another aspect of the system, the translatory shaft projects from a fist end of the motor and the motor is coupled at a second end thereof to the bezel.

In still a further aspect of the system, a third LED lamp unit is positioned laterally of and outboard of the second LED lamp unit, the third LED lamp unit having a pivotal connection to the bezel and a pivotal connection to the link, and thus having a pivotal connection to the axially translatory shaft.

In still a further embodiment of the system, the lever arm distances between the pivotal bezel connection and pivotal link connection of the LED lamp unit differ, whereby the LED lamp units swivel about respective pivotal frame connections through different angular distances at different rates.

In still another embodiment of the system, each LED lamp unit has a copivoted LED lamp unit stacked thereon.

### BRIEF DESCRIPTION OF THE DRAWINGS

From the foregoing description, one skilled in the art can easily ascertain the essential characteristics of this invention, and without departing from the spirit and scope thereof, can make various changes and modifications of the invention to adapt it to various usages and conditions.

FIG. 1 is a top view through a left hand AFL headlamp assembly of a prior art which uses a HID projection lamp light source;

FIG. 2 is a top view of a left hand LED headlamp assembly configured in accordance with the principles of the present invention, showing LED lamp unit positions when the vehicle is traveling straight;

FIG. 3 is a front view of the system of FIG. 2;

FIG. 4 shows rotation of the LED lamp units from the FIG. 2 position to a right turn position;

FIG. 5 shows rotation of the LED lamp units from the FIG. 2 position to a left turn position;

FIG. 6 is a top view of a second embodiment of the invention;

FIG. 7 is a top perspective view of an LED headlamp assembly in accordance with a third embodiment of the present invention;

FIG. 8 is a front view of the headlamp assembly of FIG. 5, and

FIG. 9 is a side elevation along lines 9-9 of FIG. 8.

### DETAILED DESCRIPTION OF THE DRAWINGS

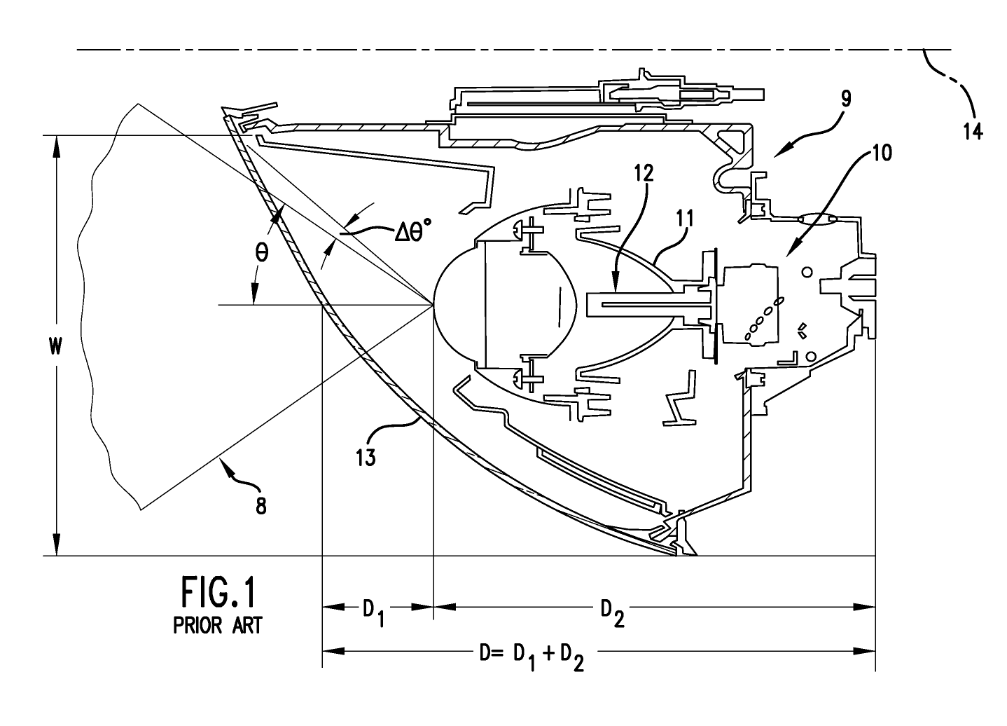

Referring now to FIG. 1 where an AFL system 10 of a vehicle headlamp assembly 9 having a projector lamp 11 with an HID light source 12 is shown, it is seen that the system has a width W, a length D and a light transmission clearance zone angle Θ of about 41° for the projector light cone 8. The angle ΔΘ° rotation equates to a 5° inboard rotation of the projector lamp 11 toward the longitudinal axis 14 of the vehicle. As will be apparent from the following discussion, by utilizing a LED headlamp assembly configured in accordance with the present invention, both the width W and the length D₁ are substantially reduced, while the angle of rotation ΔΘ is substantially increased.

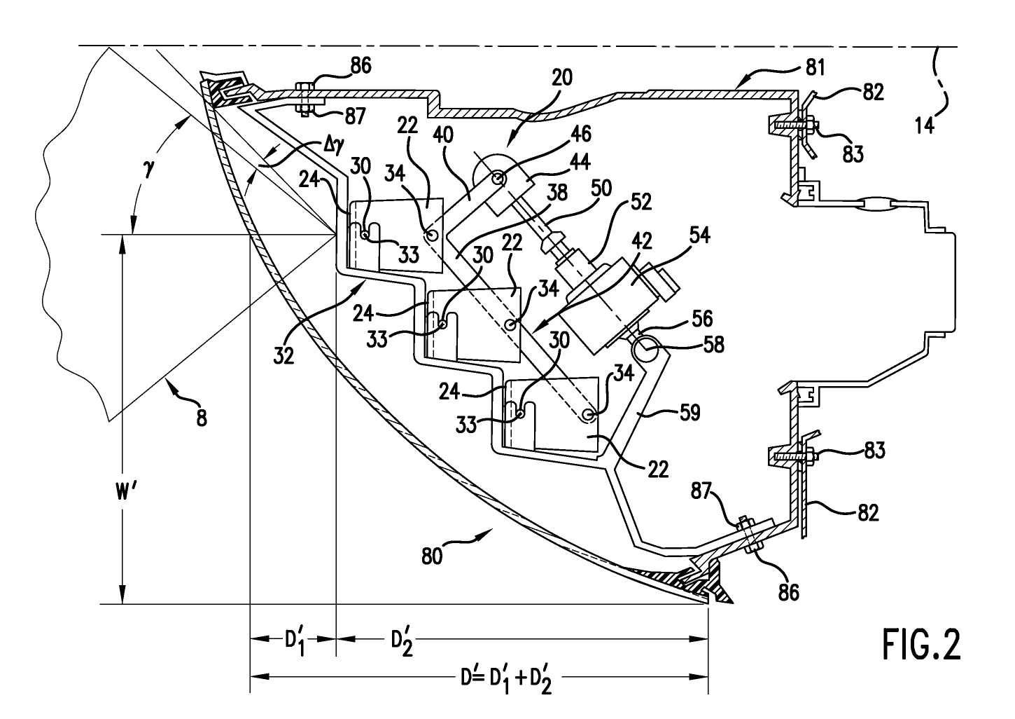

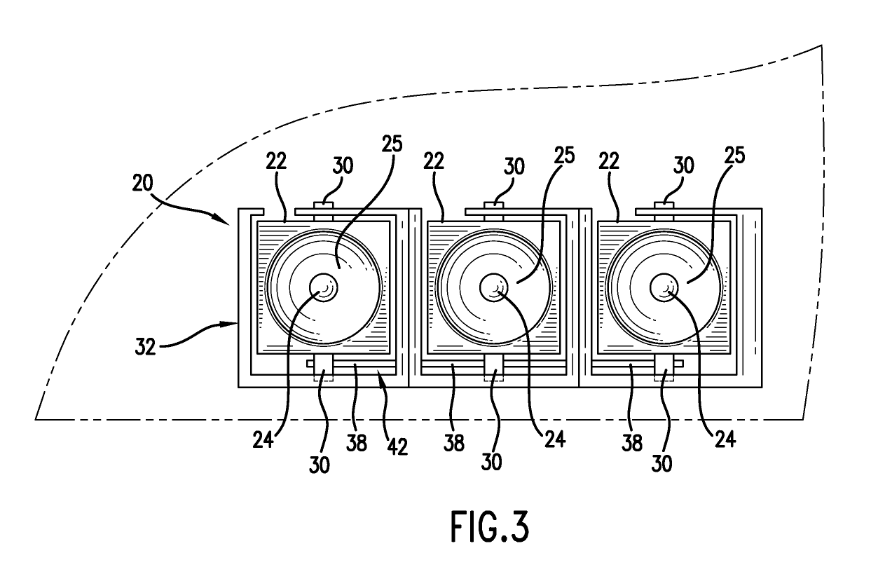

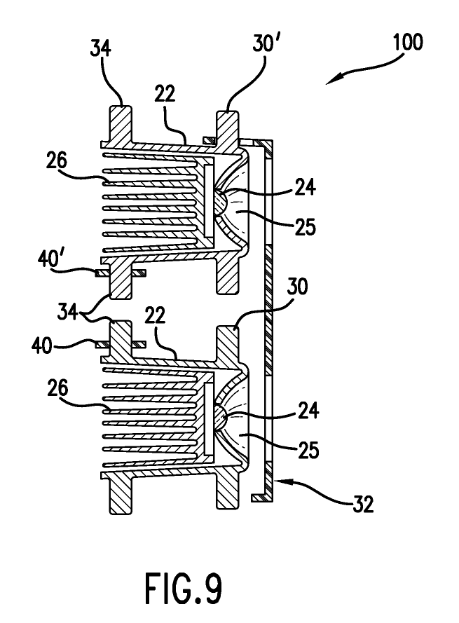

Referring now to FIGS. 2-5, an LED AFL system 20 is shown that uses LED lamp units 22 rather than using the projector lamp 11. Each lamp unit 22 has an LED 24 (see FIG. 3) thereon which function as a light source that faces forwardly and has a parabolic reflection cup 25 with a direction of focus normally parallel to the longitudinal axis 14 of the vehicle upon which the LED AFL headlamp assembly 80 is mounted. The heat of each LED 24 is dissipated by a heat sink 26 (see FIG. 9). Each of the LED lamp units 22 is mounted to the automotive vehicle by a mounting pivot 30, which pivotal connection is preferably fixed with respect to a bezel 32 mounted in the body of the headlamp assembly housing 81. In the arrangement of FIGS. 2-5, the LED lamp units 22 are disposed laterally of one another with respect to the axis 14 of the vehicle to provide laterally positioned lamp units.

The headlamp assembly housing 81 is secured to the vehicle body 82 by threaded studs and nuts 83, while the bezel 32 is secured within the housing 81 by bolts 86 and nuts 87.

Each of the LED lamp units 22 is rotatable about a vertical axis 33 and each of the LED lamp units 22 has a link pivot 34, which is spaced from the mounting pivot 30 and is rotatably connected to a long link portion 38. The long link portion 38 is unitary with a short link portion 40 to provide a L-shaped linkage 42. The short link portion 40 is pivoted to a clevis 44 by a pivot 46. The clevis 44 is coupled to a translatory shaft 50 that is driven by an output gear 52 that converts rotational motion from an electric motor 54 to linear motion to translate the shaft 50.

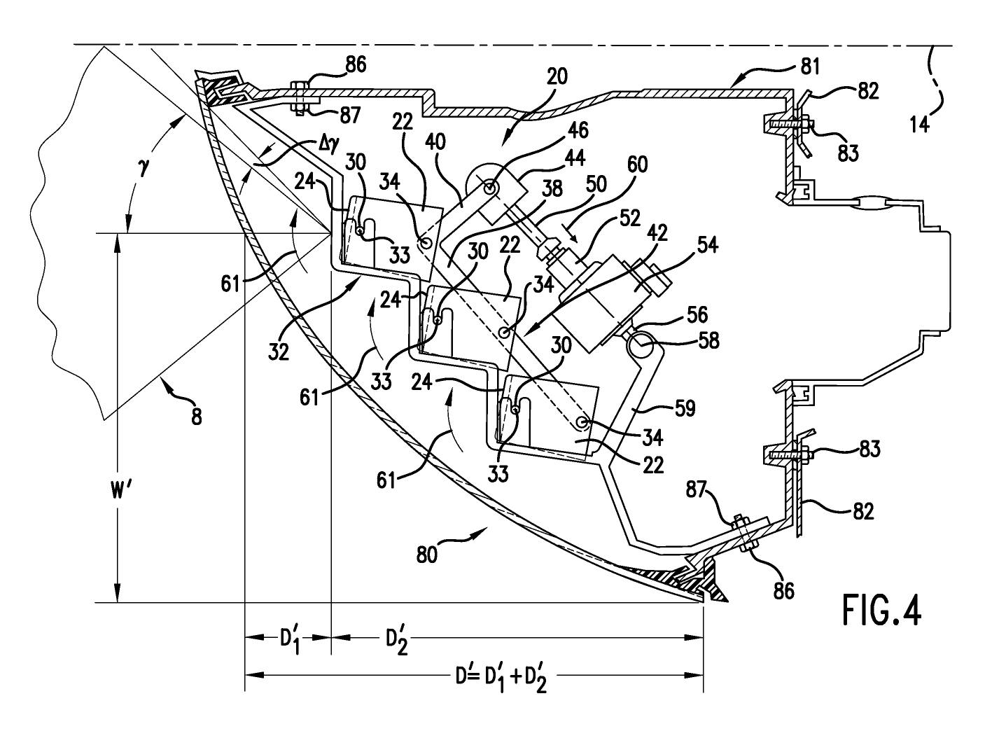

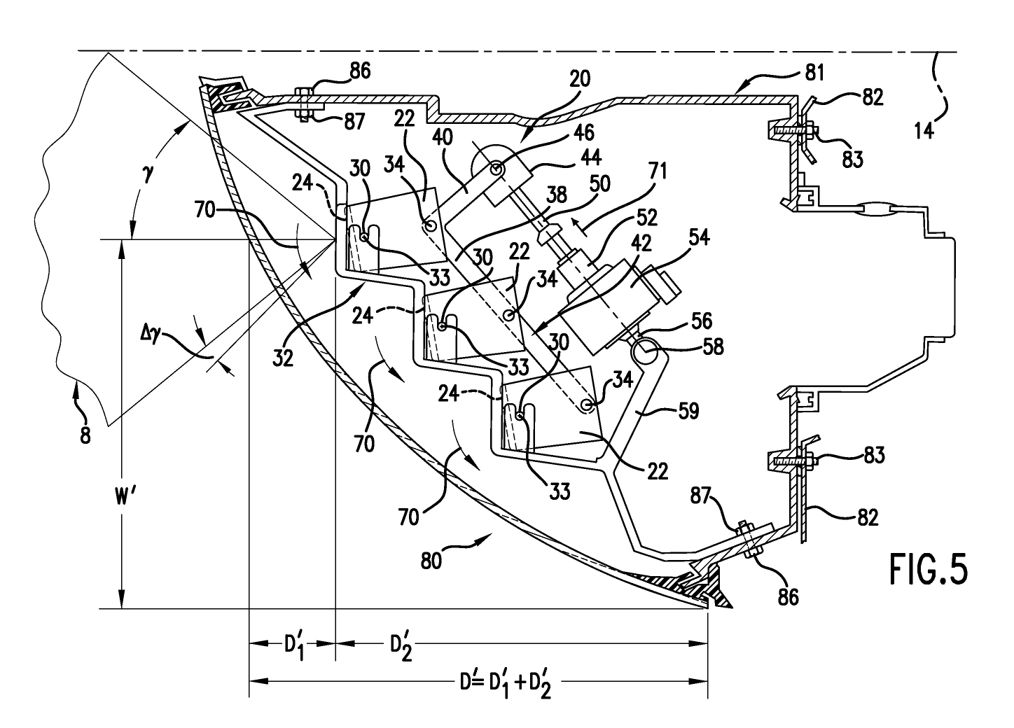

The electric motor 54 has an axial mounting rod 56 that is axially aligned with the translatory shaft 50 and is attached by a pivot pin 58 to a portion 59 of the bezel 32 that supports the LED lamp units 22. By mounting the electric motor 54 pivotally on to the bezel 32, pivotal adjustments are made to accommodate changes in position as the linkage 42 shifts due to translation of the shaft 50 that results in repositioning of the LED lamp units 22, as is shown in FIGS. 4 and 5. The electric motor 54 combines with the bezel 32 and the LED lamp units 22 to form a package conveniently insertable into a vehicle.

The width W′ and length D′₁ of the LED headlamp assembly 80 of FIGS. 2-5 are substantially less than the width W and length D₁ of the headlamp assembly 9 of FIG. 1, allowing greater design flexibility.

When driving straight ahead, the LED lamp units 22 are directed straight ahead, i.e., parallel to the vehicle axis 14 as shown in FIG. 2. As is seen in FIG. 4, upon turning the steering wheel of the vehicle clockwise to turn the vehicle to the right, the translatory shaft 50 moves inward toward the motor 54 in the direction of arrow 60. This causes linkage 42 to also move in the general direction of arrow 60. The movement of the short link portion 40 allows the LED lamp units 22 connected by the pivots 34 to the long link portion 38 to rotate in a clockwise direction 61 about the pivots 30, thus directing their light beams toward the longitudinal axis 14 of the vehicle. As is seen in FIGS. 2 and 4, it is possible to rotate the LED lamp units 22 about 12° inboard, Δγ, which equates to a 240% increase in inboard rotation with respect to the prior art projector lamp 11 of FIG. 1, which has only 5° of angular movement obtainable. Consequently, by utilizing the LED headlamp assembly 80 of the present invention, inboard rotations are substantially increased over rotations available from the prior art, which in combination with a smaller headlamp package provide a clear improvement in both performance and space utilization as compared to prior art AFL systems using the HID projector lamp 11 of FIG. 1.

Referring now to FIG. 5, when the steering wheel of the vehicle is rotated counterclockwise to turn the vehicle to the left, the LED lamp units 22 pivot about the mounting pivots 30 to rotate counterclockwise in the direction of arrows 70. This rotation is accomplished by projecting of the translatory shaft 50 outwardly from the electric motor 54, which pushes the L-shaped linkage 42 in the direction of arrow 71, thus also moving the pivots 34 on the LED lamp units 22 in the direction of the arrow 71. The LED lamp units 22 thus direct their light beams more to the left as the vehicle turns left. When making a left hand turn, the illustrated left LED AFL headlamp assembly 80 is substantially unobstructed by the bezel 32 within which the AFL system is mounted versus inboard rotations of the AFL system discussed above which have rotational limitations.

In order to accommodate pivotal and sliding motion between the L-shaped linkage 42 and the LED lamp units 22, the long link portion 38 may engage the link pivots 34 with slots having a transverse orientation with respect to the long link portion. The short link portion 40 may engage the pivot 46 on the clevis 44 with a slot and the motor 54 may have a pin-in-slot connecting the bezel portion 60, via the pin 58.

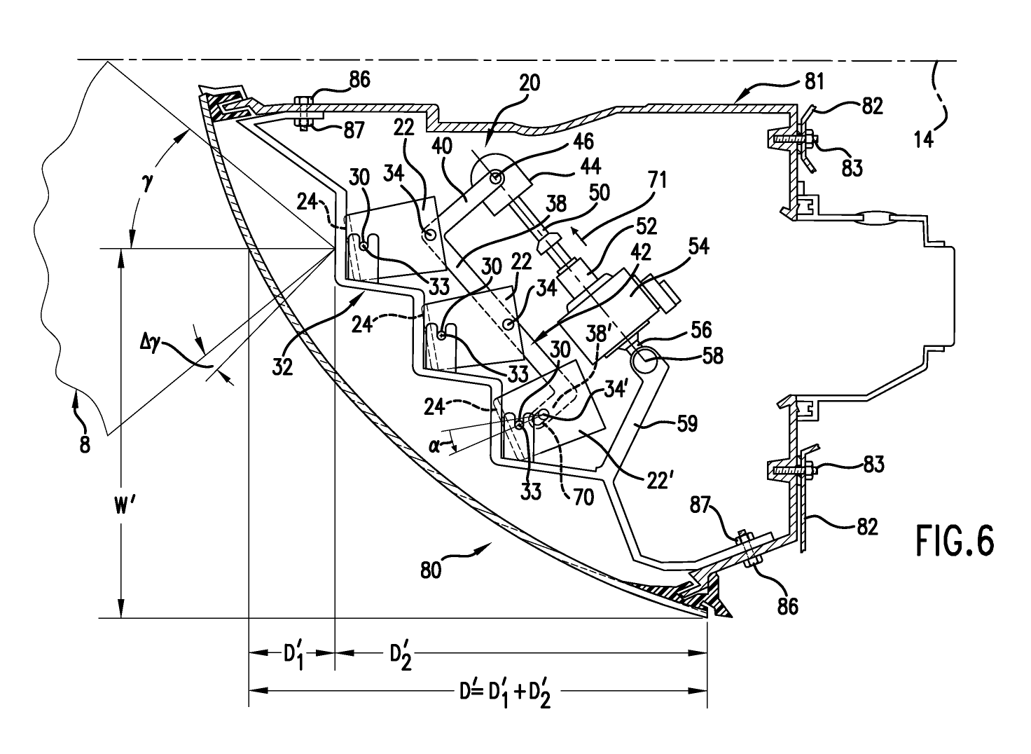

Referring now to FIG. 6, where a second embodiment of the invention is shown, the outboard LED lamp unit 22′ is rotated a further angular distance a by moving the link pivot 34′ closer to the mounting pivot 30. The link pivot 34′ of FIG. 6 is engaged by a lateral extension 38′ of the long link portion 38. The lateral extension 38′ has a slot 70 which provides sufficient lost motion to keep the long link 38 from binding with the pivot 34′. By utilizing such an arrangement, the outer lamp unit 22′ can pivot further than the two inner LED lamp units 22 because the lever distance between the pivots 30 and 34′ is less. Consequently, the same movement of the longer link 38 results in increased angular movement of the outer LED lamp unit 22′.

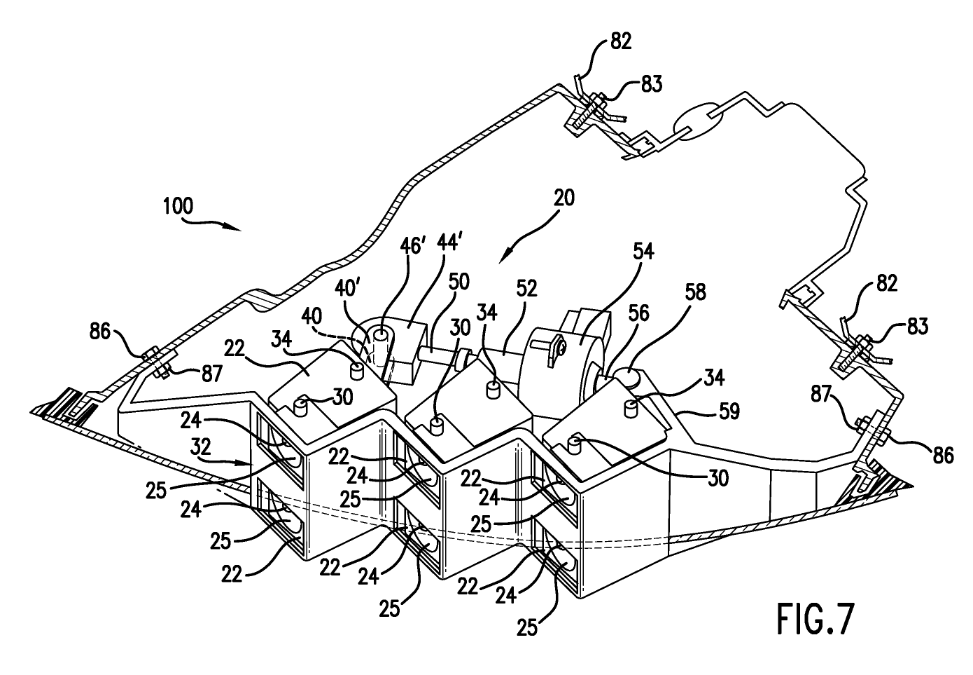

Referring now to FIGS. 7-9, where a further embodiment 100 of the LED AFL system 20 is shown, additional LED lamp units 22 are stacked vertically so that there are two LED lamp units 22 at each horizontal location and pivoted to the link pivots 34.

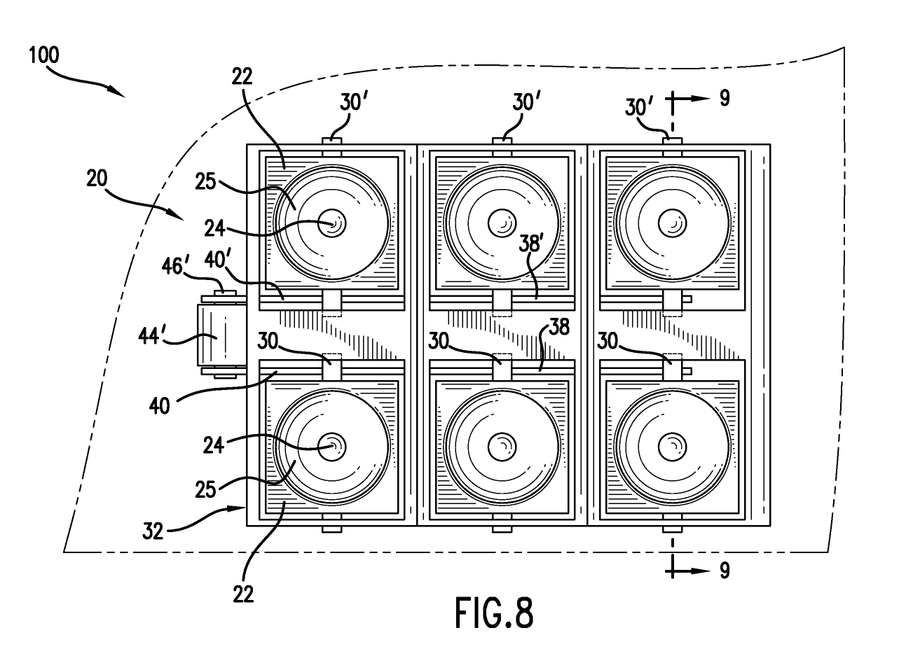

In the embodiment 100 there are a pair of links 40 and 40′ pivoted to the clevis 44′ by the pivot 46′. A single motor 54 drives the translating shaft 50 that moves the clevis 44′. The LED lamp units 22 pivot about pivots 30 and 30′ attached to the bezel 32 in the same way the lamp units pivot in FIGS. 2-6. As is seen in the front view of FIG. 8, and the elevation of FIG. 9, each of the lamp units 22 include a single LED 24 and within a parabolic reflection cup 25. Each LED is cooled by a heat sink 26. While single LED lamp units 22 are shown each light source in other embodiments of the invention may include multiple LEDs.

While FIGS. 7-9 show LED light sources stacked for operation by linkages 42 and 42′, in other embodiments the LED lamp units can be positioned randomly in lateral, vertical or for/aft relationship to one another to meet appearance packaging requirements. Such arrangements utilize a variety of different linkage mechanisms to pivot the LED lamp units 22. While in the illustrated embodiment L-shaped linkages 22 are used, separate linkages can be used to achieve different positions for the LED lamp units 22.

From the foregoing description, one skilled in the art can easily ascertain the essential characteristics of this invention, and without departing from the spirit and scope thereof, can make various changes and modifications of the invention to adapt it to various usages and conditions.

We claim:

1. An LED adaptive forward lighting system for an automotive vehicle, comprising:
a bezel fixed to a headlamp housing of a vehicle for mounting at least a first LED lamp unit;
at least one LED lamp unit having a fixed light beam direction, the LED lamp unit having a mounting pivot and a link pivot thereon that are spaced from one another to provide a lever arm, the mounting pivot mounting the LED lamp units on the bezel;
a motor restrained with respect to the vehicle, the motor driving an axially translatory shaft;
a link pivoted to the link pivot on the LED lamp unit and pivoted to the axially translatory shaft wherein when the axially translatory shaft translates, the LED lamp unit rotates the light beam thereof with respect to a longitudinal axis of the vehicle.

2. The system of claim 1 wherein there is at least a second LED lamp unit pivoted to the bezel, with each LED lamp unit being pivotally connected to the link and thus to the axially translatory shaft.

3. The system of claim 2 wherein the second LED lamp unit is positioned laterally of the first LED lamp unit.

4. The system of claim 2 wherein there are additional LED lamp units mounted adjacent to the first and second LED lamp units, the additional lamp units each having a mounting pivot and a link pivot.

5. The system of claim 3 further including a third LED lamp unit positioned laterally of and outboard of the second LED lamp unit, the third LED unit having a pivotal connection to the bezel and a pivotal connection to the link, and thus having a pivotal connection to the axially translatory shaft.

6. The system of claim 5, wherein the distances between the mounting pivot and the link pivot of the LED lamp units define lever arms of different lengths, whereby the LED lamp units swivel about respective mounting pivots through different arcuate distances at different rates.

7. The system of claim 6 wherein the third LED lamp unit has a shorter lever arm distance than the other LED lamp units, wherein the third LED lamp unit rotates through a greater distance at a faster rate than the other LED headlamp units.

8. The system of claim 5 wherein there are additional LED lamp units mounted adjacent to the first, second and third LED lamp units, the additional lamp units each having a mounting pivot and a link pivot.

9. The system of claim 1 wherein the translatory shaft projects from a first end of the motor and the motor is coupled at a second end thereof to the bezel.

10. An LED adaptive forward lighting system for an automotive vehicle, comprising:
a bezel fixed to a headlamp housing of the vehicle;
a plurality of LED lamp units, each LED lamp unit having a fixed light beam direction and having a mounting pivot and a link pivot thereon, the mounting pivots mounting the LED lamp units on the bezel and the link pivots being spaced from the mounting pivots to provide a lever arm for each LED lamp unit;
a motor restrained with respect to the vehicle, the motor driving an axially translatory shaft;
a link pivoted to the link pivots on the LED lamp units and pivoted to the axially translatory shaft, wherein when the axially translatory shaft translates, the LED lamp units rotate the light beams thereof with respect to a longitudinal axis of the vehicle.

11. The system of claim 10, wherein the translatory shaft projects from a first end of the motor and the motor is coupled at a second end thereof to the bezel.

12. The system of claim 10 wherein the LED units are disposed laterally with respect to one another to provide laterally positioned units.

13. The system of claim 12 wherein additional LED units are disposed vertically with respect to the laterally positioned units.

14. The system of claim 13, wherein the additional LED lamp units each having a mounting pivot and a link pivot aligned with respective mounting and link pivots of the laterally positioned LED lamp units.

15. The system of claim 14, wherein the translatory shaft projects from a first end of the motor and the motor is coupled at a second end thereof to the bezel.

16. The system of claim 10, wherein the distances between the mounting pivot and the link pivot of the LED lamp units define lever arms of different lengths, wherein the LED lamp units swivel about respective mounting pivots through different arcuate distances at different rates.

17. The system of claim 16 wherein at least one LED lamp unit positioned outboard of the other LED lamp units has a shorter lever arm distance than the other LED lamp units, wherein at least one LED lamp unit rotates through a greater distance at a faster rate than the other LED headlamp units.

18. The system of claim 16, wherein the translatory shaft projects from a first end of the motor and the motor is coupled at a second end thereof to the bezel.
